(19) United States
(12) Patent Application Publication
(10) Pub. No.: US 2024/0328467 A1
(43) Pub. Date: Oct. 3, 2024

(54) CLUTCH D HUB FOR AUTOMATIC TRANSMISSION

(71) Applicant: Sonnax Transmission Company, Bellows Falls, VT (US)

(72) Inventors: Jeffrey Robichaud, Hinsdale, NH (US); Dylan Sebastian LaLone, Dummerston, VT (US); Brian Wing, Chester, VT (US)

(73) Assignee: Sonnax Transmission Company, Bellows Falls, VT (US)

(21) Appl. No.: 18/614,174

(22) Filed: Mar. 22, 2024

Related U.S. Application Data
(60) Provisional application No. 63/455,111, filed on Mar. 28, 2023.

(51) Int. Cl. F16D 13/64

(52) U.S. Cl. CPC F16D 13/644; F16D 2200/0021

(57) ABSTRACT

A clutch D hub for a transmission having first and second clutch packs and a shaft. A drum has a bottom wall and a sidewall extending therefrom. The bottom wall has an opening and the sidewall has splines formed in an inner surface that extend from an upper edge toward the bottom wall. The splines are engageable with the first clutch pack during operation. A spline hub formed separately from the drum has a top wall and a skirt extending therefrom. The top wall of the spline hub is coupled to the bottom wall of the drum to be non-rotatable relative thereto, so an opening in the top wall coaxially aligns with the opening in the bottom wall of the drum so the shaft is receivable therethrough. The spline hub has axially oriented splines formed in an outer surface, which are engageable with the second clutch pack during operation.

### CROSS REFERENCE TO RELATED APPLICATION

This application claims the benefit of U.S. Provisional Patent Application No. 63/455,111, filed Mar. 28, 2023, which is incorporated herein by reference in its entirety.

### FIELD

The present disclosure generally relates to automatic transmissions, and more particularly to clutch D hubs of automatic transmissions.

### BACKGROUND

The following description relates generally to a clutch D hub, and more particularly an improved clutch D hub.

The clutch D hub is a component in an automatic transmission in which a number of the transmission components, such as clutch plates and planetary gear sets, are located. The clutch D hub (also referred to as a D hub), includes a larger diameter cup-shaped body or barrel, and a smaller diameter spline skirt or spline hub having axially oriented splines formed therein.

Presently, original equipment manufacturer (OEM) D hubs are unitary components formed from cast A383 aluminum. That is, the cup-shaped structure and the clutch plates are positioned around the skirt and engage and disengage the splines during normal operation of the vehicle. The clutch plates have a steel core. By way of example, one commercially available OEM D hub is part number 1090-373-062 by ZF Friedrichshafen AG.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One aspect of the present disclosure generally relates to a clutch D hub for an automatic transmission having a first clutch pack, a second clutch pack, and a shaft. A cup-shaped drum has a bottom wall and a cylindrical sidewall that extends therefrom, the bottom wall having an opening therein, and the sidewall having a plurality of splines formed in an inner surface thereof extending from an upper edge toward the bottom wall, the plurality of splines being configured to engage with the first clutch pack during operation. A spline hub formed separately from the drum has a top wall and a cylindrical skirt that extends therefrom. The top wall of the spline hub is coupled to the bottom wall of the drum such that the drum and the spline hub are non-rotatable relative to one another and such that an opening in the top wall of the spline hub is coaxially aligned with the opening in the bottom wall of the drum so as to be configured to receive the shaft therethrough. The spline hub has a plurality of axially oriented splines formed in an outer surface thereof that are configured to engage with the second clutch pack during operation.

In certain examples, the spline hub comprises steel.

In certain examples, a sleeve is positioned within the opening in the spline hub. In certain examples, the sleeve extends axially in both directions relative to the top wall of the spline hub. In certain examples, an upwardly extending portion of the sleeve is positioned within the opening in the bottom wall of the drum. In certain examples, a bushing is positioned within the sleeve. In certain examples, the bushing is a bi-metal bushing or comprises bronze, aluminum, a PTFE-impregnated material, or a PTFE material attached with a thermal compound.

In certain examples, the drum and spline hub are coupled to one another at least in part via rivets.

In certain examples, the spline hub includes a plurality of axially oriented channels formed in an inner surface thereof located to correspond to at least a portion of the plurality of axially oriented splines on the outer surface. In certain examples, through-wall openings are formed in the channels.

In certain examples, openings are formed in the drum sidewall.

In certain examples, the upstanding cylindrical sidewall of the drum defines an interior space, where the bottom wall of the has a lip extending away therefrom about a periphery of the opening in the bottom wall, and where the lip extends inwardly into the interior space.

Another aspect according to the present disclosure generally relates to a kit for replacing a replacing an OEM clutch D hub for an automatic transmission having a first clutch pack, a second clutch pack, and a shaft. The kit includes a cup-shaped drum having a bottom wall and a cylindrical sidewall that extends therefrom, the bottom wall having an opening therein, and the sidewall having a plurality of splines formed in an inner surface thereof extending from an upper edge toward the bottom wall, the plurality of splines being configured to engage with the first clutch pack during operation. The kit further includes a spline hub formed separately from the drum and having a top wall and a cylindrical skirt that extends therefrom, wherein the top wall of the spline hub is configured to be coupled to the bottom wall of the drum such that the drum and the spline hub are non-rotatable relative to one another and such that an opening in the top wall of the spline hub is coaxially aligned with the opening in the bottom wall of the drum so as to be configured to receive the shaft therethrough, the spline hub having a plurality of axially oriented splines formed in an outer surface thereof that are configured to engage with the second clutch pack during operation.

In certain examples, a backing ring is configured for positioning at the splines of the drum.

In certain examples, the splines of the spline hub comprise steel.

Another aspect of the present disclosure generally relates to a method for replacing an OEM clutch D hub for an automatic transmission having a first clutch pack, a second clutch pack, and a shaft. The method further includes separating the OEM clutch D hub, the shaft, the first clutch pack, and the second clutch pack, and obtaining a replacement clutch D hub. The replacement clutch D hub includes a cup-shaped drum having a bottom wall and a cylindrical sidewall that extends therefrom, the bottom wall having an opening therein, and the sidewall having a plurality of splines formed in an inner surface thereof extending from an upper edge toward the bottom wall. The replacement clutch D hub further includes a spline hub formed separately from the drum and having a top wall and a cylindrical skirt that extends therefrom, wherein the top wall of the spline hub is coupled to the bottom wall of the drum such that the drum and the spline hub are non-rotatable relative to one another and such that an opening in the top wall of the spline hub is coaxially aligned with the opening in the bottom wall of the drum so as to be configured to receive the shaft therethrough, the spline hub having a plurality of axially oriented splines formed in an outer surface thereof. The method further includes positioning the shaft in the opening of the drum and in the opening of the spline hub, positioning the first clutch pack so as to be engageable with the plurality of splines of the drum during operation of the automatic transmission, and positioning the second clutch pack so as to be engageable with the plurality of splines of the spline hub during operation of the automatic transmission.

In certain examples, the method further includes positioning a backing ring proximate the drum splines.

In certain examples, the method further includes positioning a sleeve within the opening in the drum and the opening in the spline hub. In certain examples, the method further includes positioning a bearing within the sleeve and positioning the shaft so as to extend through the bearing.

In certain examples, the method further includes positioning a bearing within the opening in the drum and the opening in the spline hub.

It should be recognized that the different aspects described throughout this disclosure may be combined in different manners, including those than expressly disclosed in the provided examples, while still constituting an invention accord to the present disclosure.

Various other features, objects and advantages of the disclosure will be made apparent from the following description taken together with the drawings.

### BRIEF DESCRIPTION OF THE DRAWINGS

FIG. 1 is a cutaway perspective view of a known vehicle transmission.

FIG. 2A is a perspective view of a D hub from a known vehicle transmission such as that shown in FIG. 1.

FIG. 2B is a close-up perspective view of a known D hub such as that shown in FIG. 2A, enlarged to show some amount of wear.

FIG. 2C is a close-up perspective view of a known D hub such as that shown in FIG. 2A, enlarged to show extensive wear.

FIG. 3 is a perspective view of one embodiment of a clutch D hub according to the present disclosure.

FIG. 4 is a side-by-side split side view of the clutch D hub of FIG. 3, showing the D hub with the drum, spline hub and bushing cut away on the left hand side of FIG. 4, and a full side view of the drum, spline hub and bushing on the right hand side of FIG. 4.

FIG. 5 is a perspective view of a backing plate such as may be used with the clutch D hub of FIG. 3.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

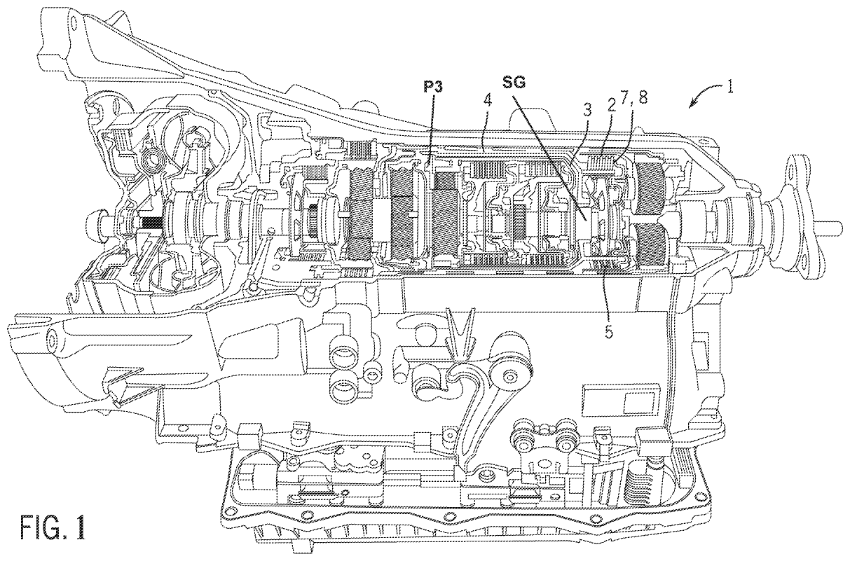

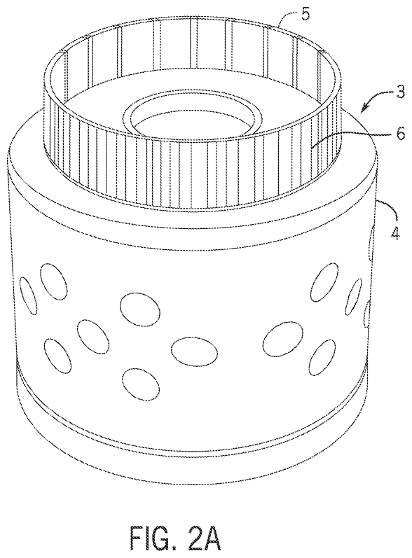

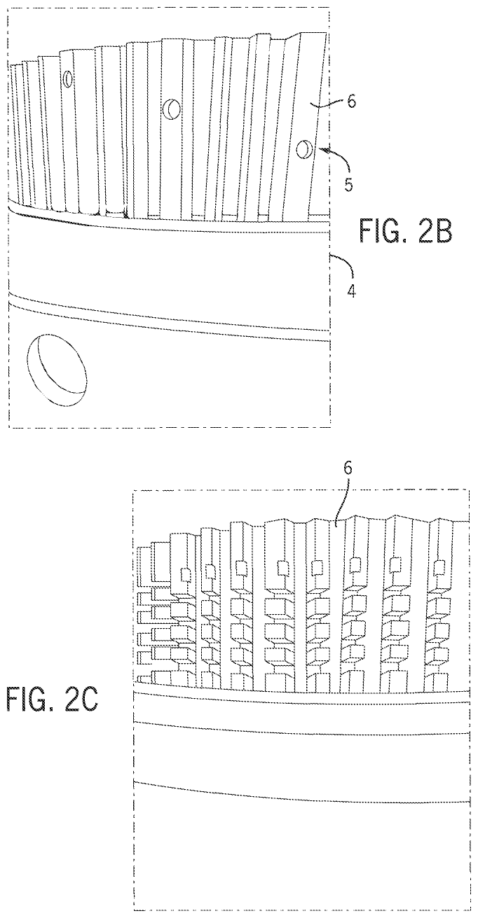

Through research and development, the present inventors have recognized that one mode of failure for OEM D hubs is wearing through the splines of the D hub skirt by the steel core of the clutch plates. FIGS. 1-3 show an example of a D hub (FIG. 1), an enlarged photograph of D hub splines exhibiting some wear (FIG. 2A), and a photograph similar to FIG. 2A, showing the D hub splines with heavy wear (FIG. 2B) and actual blow-out (FIG. 2C). It can be seen in FIG. 3 that the splines are worn through.

In some instances, wear can be visible after only a few thousand miles of using the D hub within an automatic transmission, and can result in burned-out clutches. In addition, the present inventors have recognized that the D hub backing plate can flex, which results in clutch plate friction surfaces to wear unevenly. These issues can result in high rates of failure. In certain transmissions, such as the ZF8HP transmissions produced by ZF Friedrichshafen AG of Germany, including but not limited to the ZF8HP45, ZF8HP50, ZF8HP51, ZF8HP55, ZF8HP70, ZF8HP75, ZF8HP76, ZF8HP90 and ZF8HP95 transmissions, this can result in the loss of fourth through eighth and reverse gears.

Accordingly, there is a need for an improved clutch D hub having increased strength and reliability over an OEM clutch hub. It is desired that such an improved D hub function under normal operating conditions without damage to the D hub splines, and also that such an improved D hub is configured to be a replacement to the OEM D hub without modification to other components of the transmission.

FIG. 1 is an illustration of a ZF8HP70 automatic transmission 1 as presently known in the art, which as discussed above is produced by ZF Friedrichshafen AG of Germany. The transmission 1 includes a number of clutch packs, including a D clutch 2 and a clutch D hub 3 that engages the D clutch 2. A known D hub 3 is shown in FIGS. 2A-2C. The D hub 3 includes a relatively larger diameter cup-shaped body or barrel 4 and a smaller diameter spline skirt or hub 5 having axially oriented splines 6 formed thereon. During certain vehicle operations, clutch plates 7 of clutch pack 8 engage the D hub 3 at the splines 6. The clutch plates 7 are formed from steel, whereas the D hub 3 is formed from aluminum for cost savings, weight savings, and fuel economy. As discussed above, the D hub splines 6 have been known to wear and fail as a result of the harder steel clutch plates 7 engaging the relatively softer D hub 3.

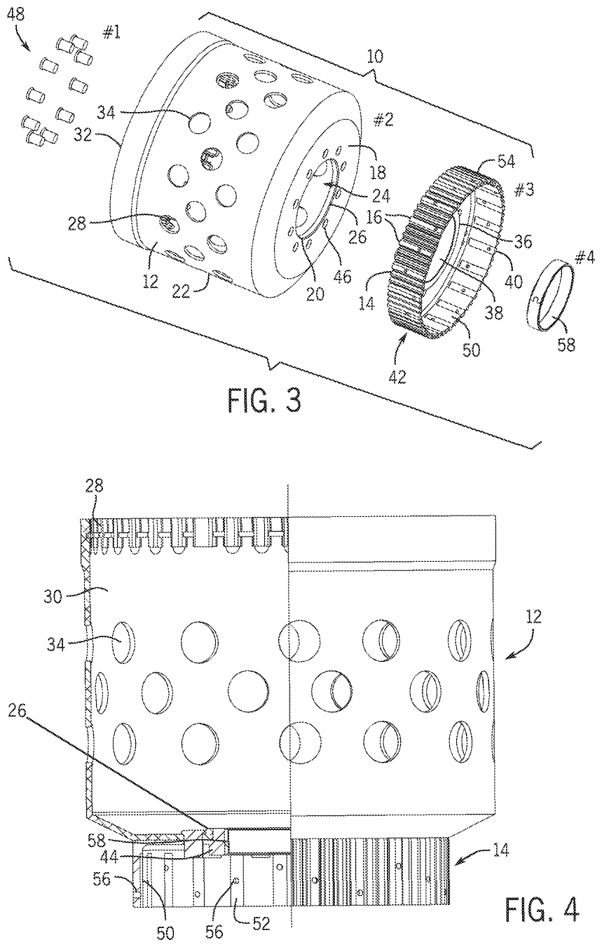

Referring to FIGS. 3 and 4, to address the known OEM D hub spline wear issues and failures, the present inventors developed a D hub 10, which is shown as a multi-piece design in accordance with the present disclosure. In embodiments, the D hub includes a larger diameter cup-shaped drum 12 and a smaller diameter spline skirt or hub 14 having axially oriented splines 16 formed thereon with the splines 16 extend radially outwardly for engaging clutch plates of the D clutch pack. The D hub drum 12 and the spline hub 14 are separate elements that are operably joined or mounted to one another as discussed in detail below.

Referring to FIG. 3, the drum 12 includes a bottom wall 18 having an opening 20 therein for receiving a shaft (sun gear SG of planet set 4, see FIG. 1) and an upstanding cylindrical side wall 22 that defines and interior space 24. A lip 26 extends axially inwardly of the interior space 24 from the opening 20. With reference to FIGS. 3 and 4, a plurality of splines 28 are formed in an inner surface 30 of the side wall 22 extending from an upper edge 32 downwardly toward the bottom wall 18. The splines 28 are configured to engage with the P3 planet carrier. Openings 34 are formed in the drum side wall 22, which are discussed further below.

In embodiments, the spline hub 14 includes a top wall 36 (FIG. 3) having an opening 38 that is coaxially aligned with drum opening 20 and has an axially extending cylindrical skirt 40. The plurality of splines 16 discussed above are formed on an outer surface 42 of the skirt 40. The spline hub top wall 36 has a collar or sleeve 44 (FIG. 4) that axially extends from the top wall 36 surrounding the opening 38, whereby the sleeve 44 is inserted into the drum opening 20. In certain embodiments, the sleeve 44 extends both upwardly and downwardly from the top wall 36 proximate the opening 38. The sleeve 44 provides for proper alignment of the spline hub 14 and the drum 12 as the sleeve 44 inserts into the drum bottom wall opening 20 to align the drum 12 and spline hub 14. The sleeve 44 may be integrally formed with the spline hub or coupled thereto via welding or other techniques known in the art. Likewise, the splines 28 may be integrally formed with the drum 12, or coupled thereto via such known techniques.

The bottom wall 18 of the drum 12 and the top wall 36 of the spline hub 14 have aligned openings 46 for receiving fasteners 48, such as rivets or bolts to secure the drum 12 and the spline hub 14 to one another. It should be recognized that the present disclosure contemplates coupling the drum 12 and the spline hub 14 to one another in other ways, such as bonding, threads between the hub and drum interface, threaded studs extending from the drum 12 and/or the spline hub 14, welding, including laser welding, mig welding, tig welding, electron beam welding, friction welding and the like, and/or fasteners such as rivets, bolts, pins, and the like, retaining rings/snap rings, press fit, spline drive and staking.

It will be appreciated that in different embodiments of a multi-piece D hub according to the present disclosure, the drum and spline hub can be operably joined or mounted to one another with an intermediary element. That is, the drum and spline hub need not be directly joined or mounted to one another, as long as the drum and spline hub are operably joined or mounted to one another to co-rotate. It will also be appreciated that the drum and spline hub need not be operably joined or mounted to one another at their respective bottom and top walls, again, as long as the drum and spline hub co-rotate.

In a current embodiment, the drum 12 and spline hub 14 are joined to one another by ten rivets 48. In certain embodiments, the drum 12, spline hub 14 and rivets 48 are formed from steel, such as a 4130 alloy steel. The drum and 12 spline hub 14 can be various material combinations, for example, the drum 12 can be aluminum and the spline hub 14 can be steel, the drum 12 can be steel and the spline hub 14 can be aluminum, and the drum 12 and spline hub 14 can be aluminum.

With continued reference to FIGS. 3 and 4, an inner surface 50 of the spline hub 14 includes axially oriented channels 52 that extend from a bottom edge 54 of the skirt 40 toward the top wall 36. In embodiments, the channels 52 are formed in the inner surface 50 corresponding to spline 16 locations on the outer surface 42. Openings 56 (FIG. 4) can be formed in the channels 52. The openings 56 in the channels 52 and the openings 34 in the drum side wall 22 provide for flow paths for circulation of fluid around the transmission components. Whereas the channels for OE hubs are formed via casting, the presently disclosed channels may be formed by milling for improved accuracy.

In certain embodiments, a bushing 58 can be positioned within the spline hub sleeve 44, which for example may be a bi-metal precision bushing. It should be recognized that bearings are not provided in OE devices since the aluminum is a sufficient bushing/bearing surface for engaging with steel. Other suitable bushing materials include bronze such as solid bronze, aluminum, a PTFE-impregnated material, PTFE attached with thermal compound, and other known automatic transmission bushing materials commonly in use. In embodiments, for example if the drum or hub is aluminum, the bushing may be omitted such that the aluminum inner diameter of the spline hub sleeve 44 instead serves as a bushing.

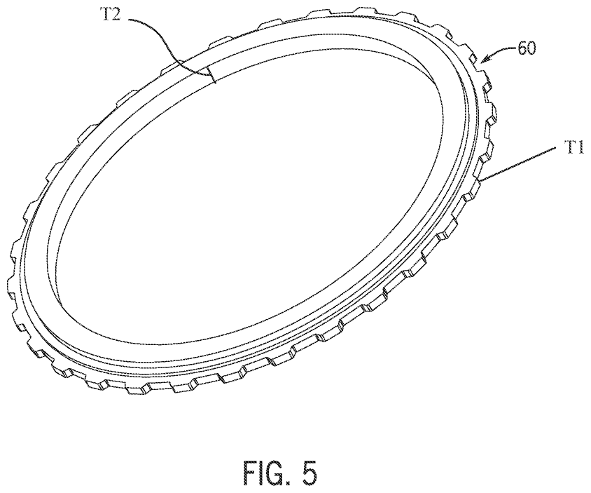

An improved backing plate 60 is illustrated in FIG. 5. Backing plates known in the art are stamped components. The backing plate 60 disclosed herein can be formed as a forged, cast or billet component to a create a profile that may be other than uniform in thickness if desired, or if desired, the backing plate may be a stamped component. In certain embodiments, the backing plates 60 are forged and then machined to achieve the desired dimensions. In addition the improved backing plate 60 has a slightly deeper profile (i.e., increased thickness) by about .150 inches to increase strength, prevent uneven wear of clutch plate friction surfaces (e.g., prevent friction plate flexing), and to compliment the overall increased strength of the D hub 10. It should be recognized that the backing plate sits on top of the D clutch pack. Known backing plates are stamped and thus limited to having a constant thickness. The improved backing plate disclosed herein is not stamped, but rather forged and machined. The present inventors have recognized that this advantageously allows backing plates to have a variable thickness (e.g., a greater thickness T2 radially inwardly of a lesser thickness T1), and thus increased material where feasible to add further strength. The present inventors have further recognized that the variable thickness is preferably not provided via casting due to negative impacts on stiffness, flatness, and surface finishing requirements for the friction reaction surface.

The present inventors have further recognized that the backing plate 60 having a deeper profile results in a larger bending moment of inertia. The increased bending moment of inertia is provided by utilizing the functional clearance that exists in an OE assembly, which still providing the same mating surfaces and features necessary to function with the other OE parts and spacing.

The improved D hub 10 can be provided as a kit. Such a kit includes the drum 12 and the spline hub 14 and may include the fasteners 48 (e.g., the rivets), the bushing 58 and the backing plate 60. The drum 12 and spline hub 14 may be provided separate from one another or may be provided pre-operably joined or mounted to one another.

It should be appreciated that in order for the present improved D hub 10 to function properly as a replacement, the overall internal and external dimensions of the D hub 10, including the drum 12, spline hub 14, bushing 58, and backing plate 60 are identical or nearly identical to the OEM D hub. In this manner, the present improved D hub 10 can replace the OEM D hub to provide increased strength and reliability with no modifications to other components in the transmission. However, the improved D hub 10 may also be used for new transmission builds and is thus not limited to sizes or configurations that could function as replacements for the OEM D hub, nor that can be used without require any modification to other OEM parts in an automatic transmission.

In this manner, it should also be appreciated that the present improved clutch D hub 10 provides increased strength and reliability over an OEM clutch hub, and functions under normal operating conditions without damage to the D hub splines 16. In contrast to the OEM D hub, which has aluminum splines that get damaged over time from engagement with clutch plates having steel cores, the D hub splines 16 according to the present disclosure can also be formed of steel or other more durable materials to prevent such damage thereto. Additionally, the drum 12 (and/or the spline hub 14) may be formed of a different material than the D hub splines 16, such as aluminum, to reduce the overall mass of the D hub 10 and thus provide improved performance over an entirely steel D hub 10. In certain embodiments, it is advantageous for the spline hub 14 to be a uniform material composition that includes the splines 16 integrally formed therewith. However, the spline hub 14 and drum 12 may advantageously be provided as different materials from each other.

It will also be appreciated that the present improved D hub provides other advantages over known or OEM D hubs. One such advantage is in manufacturing the D hub. The known single piece design is difficult and costly to manufacture as it is a cast component that requires complex and costly machining. The present improved D hub significantly reduces the amount (e.g., labor) associated with manufacturing the part in that any machining needed subsequent to casting is less complex.

It is understood that the features described with respect to any of the embodiments above may be implemented, used together with, or replace features described in any of the other embodiments above. It is also understood that description of some features may be omitted in some embodiments, where similar or identical features are discussed in other embodiments.

All patents referred to herein, are hereby incorporated herein in their entirety, by reference, whether or not specifically indicated as such within the text of this disclosure.

In the present disclosure, the words “a” or “an” are to be taken to include both the singular and the plural. Conversely, any reference to plural items shall, where appropriate, include the singular. In addition, in is understood that terminology referring to directions or relative orientations, such as, but not limited to, “upper” “lower” “raised” “lowered” “top” “bottom” “above” “below” “alongside” “left” and “right” are used for purposes of example and do not limit the scope of the subject matter described herein to such orientations or relative positioning.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A clutch D hub for an automatic transmission having a first clutch pack, a second clutch pack, and a shaft, the clutch D hub comprising:
a cup-shaped drum having a bottom wall and a cylindrical sidewall that extends therefrom, the bottom wall having an opening therein, and the sidewall having a plurality of splines formed in an inner surface thereof extending from an upper edge toward the bottom wall, the plurality of splines being configured to engage with the first clutch pack during operation; and
a spline hub formed separately from the drum and having a top wall and a cylindrical skirt that extends therefrom, wherein the top wall of the spline hub is coupled to the bottom wall of the drum such that the drum and the spline hub are non-rotatable relative to one another and such that an opening in the top wall of the spline hub is coaxially aligned with the opening in the bottom wall of the drum so as to be configured to receive the shaft therethrough, the spline hub having a plurality of axially oriented splines formed in an outer surface thereof that are configured to engage with the second clutch pack during operation.

2. The clutch D hub according to claim 1, wherein the spline hub comprises steel.

3. The clutch D hub according to claim 1, further including a sleeve positioned within the opening in the spline hub.

4. The clutch D hub according to claim 3, wherein the sleeve extends axially in both directions relative to the top wall of the spline hub.

5. The clutch D hub according to claim 4, wherein an upwardly extending portion of the sleeve is positioned within the opening in the bottom wall of the drum.

6. The clutch D hub according to claim 3, further including a bushing positioned within the sleeve.

7. The clutch D hub according to claim 6, wherein the bushing is a bi-metal bushing or comprises bronze, aluminum, a PTFE-impregnated material, or a PTFE material attached with a thermal compound.

8. The clutch D hub according to claim 1, wherein the drum and spline hub are coupled to one another at least in part via rivets.

9. The clutch D hub according to claim 1, wherein the spline hub includes a plurality of axially oriented channels formed in an inner surface thereof located to correspond to at least a portion of the plurality of axially oriented splines on the outer surface.

10. The clutch D hub according to claim 9, further including through-wall openings formed in the channels.

11. The clutch D hub according to claim 1, further including openings formed in the drum sidewall.

12. The clutch D hub according to claim 1, wherein the upstanding cylindrical sidewall of the drum defines an interior space, wherein the bottom wall of the has a lip extending away therefrom about a periphery of the opening in the bottom wall, and wherein the lip extends inwardly into the interior space.

13. A kit for replacing a replacing an OEM clutch D hub for an automatic transmission having a first clutch pack, a second clutch pack, and a shaft, the kit comprising:
a cup-shaped drum having a bottom wall and a cylindrical sidewall that extends therefrom, the bottom wall having an opening therein, and the sidewall having a plurality of splines formed in an inner surface thereof extending from an upper edge toward the bottom wall, the plurality of splines being configured to engage with the first clutch pack during operation; and
a spline hub formed separately from the drum and having a top wall and a cylindrical skirt that extends therefrom, wherein the top wall of the spline hub is configured to be coupled to the bottom wall of the drum such that the drum and the spline hub are non-rotatable relative to one another and such that an opening in the top wall of the spline hub is coaxially aligned with the opening in the bottom wall of the drum so as to be configured to receive the shaft therethrough, the spline hub having a plurality of axially oriented splines formed in an outer surface thereof that are configured to engage with the second clutch pack during operation.

14. The kit according to claim 13, further comprising a backing ring configured for positioning at the splines of the drum.

15. The kit according to claim 13, wherein the splines of the spline hub comprise steel.

16. A method for replacing an OEM clutch D hub for an automatic transmission having a first clutch pack, a second clutch pack, and a shaft, the method comprising:
separating the OEM clutch D hub, the shaft, the first clutch pack, and the second clutch pack;
obtaining a replacement clutch D hub, the replacement clutch D hub comprising:
a cup-shaped drum having a bottom wall and a cylindrical sidewall that extends therefrom, the bottom wall having an opening therein, and the sidewall having a plurality of splines formed in an inner surface thereof extending from an upper edge toward the bottom wall; and
a spline hub formed separately from the drum and having a top wall and a cylindrical skirt that extends therefrom, wherein the top wall of the spline hub is coupled to the bottom wall of the drum such that the drum and the spline hub are non-rotatable relative to one another and such that an opening in the top wall of the spline hub is coaxially aligned with the opening in the bottom wall of the drum so as to be configured to receive the shaft therethrough, the spline hub having a plurality of axially oriented splines formed in an outer surface thereof;
positioning the shaft in the opening of the drum and in the opening of the spline hub;
positioning the first clutch pack so as to be engageable with the plurality of splines of the drum during operation of the automatic transmission; and
positioning the second clutch pack so as to be engageable with the plurality of splines of the spline hub during operation of the automatic transmission.

17. The method according to claim 16, further comprising positioning a backing ring proximate the drum splines.

18. The method according to claim 16, further comprising positioning a sleeve within the opening in the drum and the opening in the spline hub.

19. The method according to claim 18, further comprising positioning a bearing within the sleeve and positioning the shaft so as to extend through the bearing.

20. The method according to claim 16, further comprising positioning a bearing within the opening in the drum and the opening in the spline hub.
